(19) United States
(12) Patent Application Publication
(10) Pub. No.: US 2026/0220621 A1
(43) Pub. Date: Jul. 30, 2026

(54) SYSTEMS AND METHODS FOR SOCIAL EVENT COORDINATION WITH SYNCHRONIZED VIEWS, PRIVACY CONTROLS, AND REAL-TIME COLLABORATION

(71) Applicant: Rachel Semaan, Washington Township, MI (US)

(72) Inventor: Rachel Semaan, Washington Township, MI (US)

(21) Appl. No.: 19/455,494

(22) Filed: Jan. 21, 2026

Related U.S. Application Data
(60) Provisional application No. 63/748,487, filed on Jan. 23, 2025.

(51) Int. Cl. G06Q 10/40

(52) U.S. Cl. CPC G06Q 10/40

(57) ABSTRACT

A computer-implemented system for social coordination includes an event creation module that receives event creation input from any authorized member within a defined user group without restriction to an administrator role. A synchronization engine maintains bidirectional data consistency between a feed view displaying event records in chronological arrangement and a calendar view displaying event records organized by date. A privacy controller assigns visibility rules based on a friend mode that restricts visibility to approved contacts or a community mode that enables visibility to members who access the group via a shareable link. A real-time communication layer transmits collaborative interactions including status updates, polling, attendance responses, and comments to participants. A group management module enables user connections via a username-based identity system without requiring phone number exchange. An audit module generates timestamped records documenting event creation, modifications, and collaborative interactions.

### CROSS-REFERENCE TO RELATED APPLICATIONS

The present application claims priority to U.S. Provisional Application No. 63/748,487 filed Jan. 23, 2025, titled “SPONTANEOUS LOCATION-BASED SOCIAL EVENT PLANNING AND DISCOVERY PLATFORM WITH REAL-TIME NOTIFICATION AND USER ENGAGEMENT,” which is hereby incorporated by reference in its entirety.

### TECHNICAL FIELD

The embodiments disclosed herein generally relate to social networking and event coordination platforms, and more specifically to systems and methods for facilitating collaborative event planning and discovery through unified feed-calendar interfaces with real-time communication capabilities.

### BACKGROUND

Social coordination among groups of friends, family members, and community networks requires efficient communication of event details including timing, location, and attendance status. Traditional approaches involve group messaging applications where users exchange text-based messages to organize gatherings, outings, and social activities. These messaging platforms require participants to scroll through conversation histories to locate event details scattered across multiple messages, often resulting in missed information and coordination failures when plans change or new participants join ongoing discussions.

Dedicated event planning platforms have emerged to address some limitations of group messaging, providing structured interfaces for creating event pages with specific fields for date, time, location, and guest lists. However, these platforms typically restrict event creation and modification permissions to designated hosts or administrators, requiring all changes to flow through a single point of control. This hierarchical permission structure creates bottlenecks when hosts are unavailable and prevents the organic, collaborative coordination that characterizes informal social planning among peers. Additionally, many existing platforms require users to share phone numbers or email addresses to establish connections, raising privacy concerns for users who prefer to limit disclosure of personal contact information.

Calendar applications provide date-based organization of events but typically operate on a single-event invitation model where each gathering requires a separate invitation workflow. These applications lack integrated communication features for real-time discussion, polling, and status updates within the context of specific events. Users must switch between calendar applications and messaging platforms to coordinate details, fragmenting the planning process across multiple interfaces and increasing the likelihood of miscommunication.

Consequently, there is a need for an improved social coordination platform that enables any authorized group member to create and modify events, provides unified visibility across multiple events within integrated feed and calendar views, supports real-time collaborative interaction within event contexts, and enables user connections without requiring exchange of phone numbers or other personal contact information.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

In one aspect, variations of the disclosed social coordination system may include a platform comprising an event database, event creation module, synchronization engine, privacy controller, and real-time communication layer. The system comprises a server hosting the platform with an event database configured to store event records comprising event titles, dates, times, durations, locations, and visibility settings aggregated into a unified data repository. The event creation module receives event creation input from any authorized member within a defined user group without restriction to an administrator role. The synchronization engine maintains bidirectional data consistency between a feed view displaying event records in chronological arrangement and a calendar view displaying event records organized by date, wherein modifications in one view automatically propagate to the other view in real-time. The privacy controller assigns visibility rules based on visibility settings comprising a friend mode restricting visibility to approved contacts and a community mode enabling visibility to members accessing the group via a shareable link. The real-time communication layer transmits collaborative interactions comprising status updates, polling, attendance response tracking, or comments to participants associated with event records. The platform enables user connections via a username-based identity system without requiring exchange of phone numbers.

In one aspect, variations of the disclosed method for facilitating event planning may include storing event records in an event database, receiving event creation input from authorized members, and generating new event records without administrator role restrictions. The method involves synchronizing a feed view and a calendar view to maintain bidirectional data consistency with automatic real-time propagation of modifications between views. The method includes assigning visibility rules based on visibility settings comprising friend mode and community mode configurations, transmitting collaborative interactions to participants including status updates, polling, attendance response tracking, or comments, and enabling user connections via a username-based identity system without requiring phone number exchange.

In one aspect, variations of the disclosed software product may include a non-transitory computer-readable storage medium having application instructions executable to store event records comprising event titles, dates, times, durations, locations, and visibility settings in an event database aggregated into a unified data repository. The instructions are executable to receive event creation input and generate new event records without administrator role restrictions, synchronize feed and calendar views with bidirectional data consistency and real-time modification propagation, assign visibility rules based on friend mode and community mode configurations, transmit collaborative interactions to participants, and enable user connections via username-based identity without phone number requirements.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a system architecture diagram, according to some embodiments;

FIG. 2 illustrates an application program and modules in communication with the computing system, according to some embodiments;

FIG. 3 is a flow diagram illustrating an exemplary operational sequence of the Event Creation Module, according to some embodiments;

FIG. 4 is a flow diagram illustrating an exemplary operational sequence of the Synchronization Engine, according to some embodiments;

FIG. 5 is a flow diagram illustrating an exemplary operational sequence of the Privacy Controller, according to some embodiments;

FIG. 6 is a flow diagram illustrating an exemplary operational sequence of the Real-Time Communication Layer, according to some embodiments;

FIG. 7 is a flow diagram illustrating an exemplary operational sequence of the Group Management Module, according to some embodiments; and

FIG. 8 is a flow diagram illustrating an exemplary end-to-end system operational flow, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The disclosed system may include at least one user device in operable communication with a network and a server configured to host and execute a social coordination platform. The terms “platform” and “application” are used interchangeably throughout this description to refer to the social coordination system and its software implementation. The social coordination platform may include multiple functional modules, each implemented in software, firmware, hardware, or any combination thereof. In some embodiments, the modules may include an Event Creation Module configured to receive event creation input from any authorized member within a defined user group and to generate new event records without restriction to an administrator role. A Synchronization Engine may maintain bidirectional data consistency between a feed view displaying event records in chronological arrangement and a calendar view displaying event records organized by date, wherein modifications in one view automatically propagate to the other view in real-time. A Privacy Controller may assign visibility rules to event records based on visibility settings comprising a friend mode that restricts visibility to approved contacts and a community mode that enables visibility to members accessing a defined user group via a shareable link. A Real-Time Communication Layer may transmit collaborative interactions comprising status updates, polling, attendance response tracking, and comments to participants associated with event records. A Notification Module may generate and transmit push notifications to participants in response to new event record creation, modifications to existing event records, or new collaborative interactions. A Group Management Module may create defined user groups, generate shareable links for group access, and add new users without requiring administrator approval. An External Sharing Module may generate shareable links for event records transmittable to external messaging or social media applications. An Audit Module may generate timestamped records documenting event record creation, modifications, attendance responses, and collaborative interactions to create activity histories. A Communication and User Interface Module may provide tab-based navigation interfaces accessible via mobile devices or web browsers and enable users to interact with the social coordination platform. A Database Engine may manage structured event data storage and retrieval operations for the Data Repository.

Conventional social coordination approaches often process event planning through fragmented messaging threads and isolated event pages, with limited ability to provide unified visibility across multiple events or enable collaborative modification without host approval. The disclosed embodiments address this problem by combining member-driven event creation with bidirectional feed-calendar synchronization, real-time collaborative interactions, and privacy-preserving username-based identity to enable efficient group coordination without administrator dependencies. This configuration enables unified, synchronized social planning that can dynamically update event visibility across multiple interface views while maintaining flexible privacy controls and collaborative interaction capabilities.

In practice and in use, the system may be deployed by groups of users coordinating social activities such as friend gatherings, family events, community meetups, or organizational activities across multiple participants and varying schedules. When a user creates an event record, the Event Creation Module may receive event data comprising title, date, time, duration, location, and visibility setting and store the record in the Data Repository via the Database Engine. The Synchronization Engine may propagate the event record to both feed and calendar views, ensuring unified visibility across interface modes. The Privacy Controller may apply visibility rules based on the selected visibility setting, restricting access to approved contacts in friend mode or enabling access to group members via shareable links in community mode. If participants submit collaborative interactions such as attendance responses, poll votes, or comments, the Real-Time Communication Layer may transmit these interactions to all associated participants in real-time. The Notification Module may generate push notifications alerting participants to new events, modifications, or interactions without requiring manual monitoring of the platform.

In this way, the system may improve social coordination by automating the synchronization of event information across multiple views, reducing reliance on fragmented messaging threads, and enabling collaborative event management through member-driven permissions. The real-time synchronization eliminates manual refresh requirements and ensures that event modifications are visible immediately across all interface views. The member-driven event creation functionality prevents coordination bottlenecks by enabling any authorized member to create or modify events without waiting for host approval. The Audit Module preserves detailed activity records, as such, the system provides documentation of event history for participant reference. These capabilities can reduce coordination latency by automating event propagation workflows, improve planning outcomes by enabling collaborative modification, and optimize communication efficiency by eliminating redundant messaging across separate threads.

Various implementations of the present disclosure involve the technical field of computer-based social coordination and event management systems for group-based planning applications, including executing algorithms to synchronize event data across multiple interface views, integrating real-time collaborative interactions into unified event contexts, applying privacy rules to control event visibility based on user relationships and group membership, generating dynamic notifications based on event creation and modification triggers, and maintaining bidirectional data consistency between chronological feed displays and date-organized calendar displays. These operations are inherently computer-based and cannot be performed in the human mind or using pen and paper due to the volume, speed, and complexity of the data being processed. For example, the system executes the steps of receiving event creation input from multiple network-connected devices, propagating event modifications to synchronized views in real-time, transmitting collaborative interactions to multiple participants simultaneously, applying visibility rules based on privacy settings and user relationships, and generating push notifications based on event triggers across distributed systems. The present disclosure amounts to more than merely implementing a generic computer as a tool to gather, analyze, and output data because the claimed operations improve the field of social coordination by enabling unified, synchronized event management that provides consistent visibility across multiple interface views rather than merely storing event information in isolated pages. In particular, the speed at which the steps of the present disclosure occur to effectuate the disclosed method, system, or product would involve real-time synchronization of event data across feed and calendar views, instantaneous transmission of collaborative interactions to multiple participants, and immediate propagation of modifications without manual refresh operations. That is, the steps of the present method, system, or product are impossible to accomplish on pen and paper, cannot be accomplished as a method of organizing human activity, and amount to more than merely gathering, analyzing, and outputting data.

Various implementations of the present disclosure include executing computer-implemented synchronization algorithms, real-time communication protocols, and privacy rule engines on computing hardware to enable coordinated social planning across distributed user devices. The computing system implements these algorithms when it performs tasks such as propagating event modifications between feed and calendar views, transmitting collaborative interactions to participant lists, applying visibility rules based on friend mode or community mode settings, generating shareable links for group access, and triggering push notifications based on event activity. In particular, the speed at which the system processes real-time collaborative interactions from multiple participants, synchronizes event data across distributed user devices, and transmits notifications when event triggers are detected would involve continuous, high-frequency data processing across networked systems. As such, the present disclosure would be impossible to accomplish on pen and paper or in the human mind due to the volume of real-time interaction data being processed, the number of simultaneous synchronization operations being performed, and the speed required to maintain data consistency across multiple interface views.

In some embodiments, the Event Creation Module processes event creation requests by receiving input from authorized members via the Communication and User Interface Module, validating member authorization within defined user groups, parsing event data comprising title, date, time, duration, location, and visibility setting, and transmitting new event records to the Database Engine for storage in the Data Repository. The Synchronization Engine executes bidirectional propagation algorithms that identify the source view of modifications, update event records in the Data Repository, propagate modifications to alternate views in real-time, and verify data consistency between feed and calendar views. The Privacy Controller receives event records with visibility settings from the Database Engine, determines whether friend mode or community mode applies, retrieves appropriate viewer lists from the Data Repository, and returns authorized viewer information to the Communication and User Interface Module. The Real-Time Communication Layer receives collaborative interactions from participants, determines interaction types, associates interactions with event records in the Data Repository, retrieves participant lists, and transmits interactions to each participant in real-time. The foregoing operations are executed as sequences of database queries, algorithmic comparisons, conditional logic evaluations, and network communications across distributed systems, and cannot practically be performed in the human mind or on paper. These concrete processing steps of real-time synchronization, collaborative interaction transmission, privacy rule application, and notification generation provide a specific improvement to social coordination systems by enabling unified visibility and collaborative modification through automated synchronization mechanisms, rather than a mere abstract idea of organizing human activity.

The disclosed social coordination platform incorporates several technical features that distinguish it from conventional event planning systems. In some embodiments, the platform may implement member-driven event creation that grants event creation and modification permissions to any authorized member within a defined user group without restriction to administrator or host roles. Each authorized member may create new event records, modify existing event records, and interact with event content through collaborative features. The Event Creation Module may enable event modification by any authorized member without requiring permission from the user who originally created the event record, ensuring that coordination is not bottlenecked through a single point of control.

In some embodiments, the platform may implement bidirectional feed-calendar synchronization that automatically propagates modifications between chronological feed displays and date-organized calendar displays. Unlike conventional systems that maintain separate event pages or require manual refresh operations to view updated information, the disclosed platform may integrate synchronization logic directly into the event management workflow. When the Synchronization Engine detects a modification to an event record in either the feed view or the calendar view, the system may automatically propagate the modification to the alternate view in real-time without requiring user-initiated refresh actions. This bidirectional synchronization ensures that event information is consistent across all interface views and that participants viewing events through different navigation paths see identical, current information.

In some embodiments, the platform may implement a dual-mode privacy controller with friend mode and community mode configurations that assigns visibility rules based on user-selected visibility settings. The Privacy Controller may adjust visibility dynamically based on the selected mode, applying friend mode restrictions that limit visibility to approved contacts associated with the creating user or community mode permissions that enable visibility to members accessing the defined user group via shareable links. When visibility settings change, such as when a user switches an event from friend mode to community mode, the system may automatically recalculate authorized viewer lists and may update event accessibility accordingly. Similarly, when group membership changes due to new users accessing shareable links, the Privacy Controller may automatically include new members in visibility calculations for community mode events.

In some embodiments, the platform may implement real-time collaborative interactions that transmit status updates, polling, attendance responses, and comments to participants without requiring page refreshes or manual polling for updates. Unlike conventional systems that may require users to refresh event pages to view new comments or updated attendance counts, the disclosed platform may enforce real-time delivery through persistent connection technologies such as WebSocket connections or server-sent events. When a participant submits a collaborative interaction such as an attendance response or poll vote, the Real-Time Communication Layer may transmit the interaction to all associated participants immediately, ensuring that collaborative discussions and planning decisions reflect current participant input without latency delays.

In some embodiments, the platform may implement username-based identity that enables user connections without requiring exchange of phone numbers or personal contact information. The Group Management Module may associate each user with a unique username that serves as the primary identifier for connection requests and group membership rather than phone numbers or email addresses. Users may connect with other users by searching for usernames or by accessing shareable links generated by the Group Management Module, enabling social coordination among users who prefer to limit disclosure of personal contact information. This username-based approach may address privacy concerns common in conventional messaging platforms that require phone number sharing to establish connections.

In some embodiments, the platform may implement link-based group joining that enables new users to join defined user groups by accessing shareable links without requiring administrator approval. The Group Management Module may generate unique shareable links for each defined user group that, when accessed by new users, automatically add those users to the group membership without requiring existing members or administrators to approve join requests. This link-based access may enable rapid group expansion for community coordination scenarios where approval workflows would create unnecessary friction, while maintaining access control through the distribution of shareable links to intended participants.

In some embodiments, the platform may implement audit-linked activity tracking that logs every event creation, modification, attendance response, and collaborative interaction with timestamps to create activity histories. The Audit Module may record not only what actions were taken but also the sequence in which actions occurred, enabling participants to review event history and understand how plans evolved over time. Each logged record may include user identifiers, action types, event record identifiers, interaction content, and precise timestamps. This comprehensive documentation may provide participants with clear visibility into coordination activity and may enable resolution of questions about when specific changes occurred or who submitted particular responses.

In some embodiments, the platform may incorporate a notification framework that generates push notifications based on event triggers including new event creation, event modifications, new attendance responses, new comments, and new poll responses. The Notification Module may interface with mobile device notification services and web browser notification APIs to deliver alerts to participants who are not actively viewing the platform interface. By establishing direct notification delivery to user devices, the platform may ensure that participants receive timely alerts about coordination activity without requiring continuous monitoring of the platform interface.

The integration with external messaging and social media applications may represent a departure from conventional event systems that operate in isolation. In some embodiments, the External Sharing Module may generate shareable links for event records that can be transmitted through external applications such as text messaging, email, Instagram, Snapchat, or other communication platforms. Users accessing these shareable links may be directed to the event record within the social coordination platform, enabling event discovery and participation by users who initially encounter the event through external channels. By establishing sharing pathways to external applications, the platform may ensure that event coordination can extend beyond users who are actively monitoring the platform interface.

The username-based identity functionality ensures that user connections are established without requiring disclosure of personal contact information. In some embodiments, the Group Management Module may enable users to search for and connect with other users by username, send connection requests that can be accepted or declined, and build networks of approved contacts for friend mode visibility without exchanging phone numbers or email addresses. This privacy-preserving connection mechanism may address a common limitation in conventional messaging and event platforms where establishing connections requires sharing personal contact information that users may prefer to keep private.

These technical features may collectively transform social coordination from a fragmented messaging process into a unified planning system. Whereas conventional systems may scatter event information across multiple messaging threads and isolated event pages, the disclosed platform may consolidate coordination through synchronized views that provide consistent visibility. By integrating member-driven event creation, bidirectional synchronization, dual-mode privacy controls, real-time collaborative interactions, and username-based identity into a unified coordination platform with automatic propagation that maintains data consistency across interface views, the system may address fundamental limitations in current social planning approaches that separate event information from collaborative discussion and fragment coordination across disconnected communication channels.

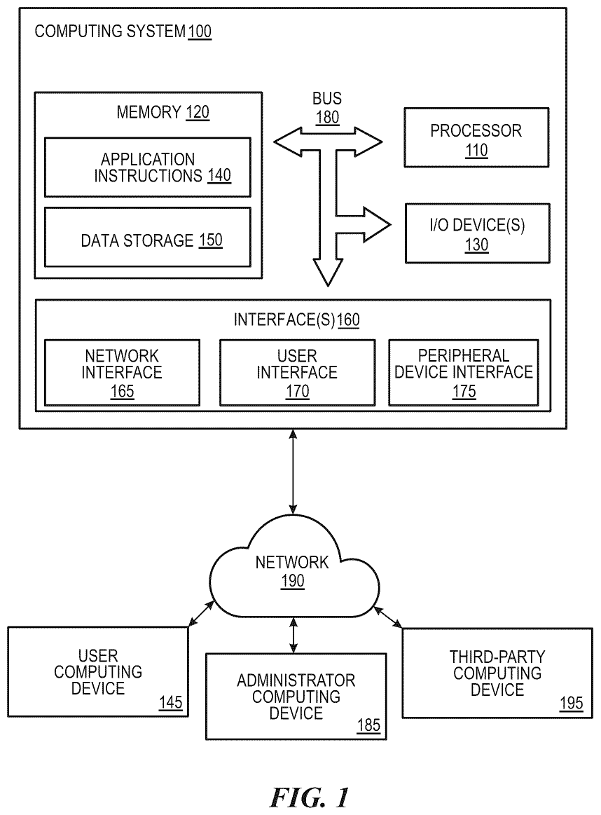

FIG. 1 illustrates an example of a computing system 100 that may provide the execution environment for implementing the processes and methods described herein. The computing system 100 may take various forms depending on deployment context, including but not limited to: a desktop or laptop computer, a tablet or smartphone, a server in a data center, a network appliance, a mainframe computer, a workstation, or a cloud-hosted virtual machine. In some embodiments, the computing system 100 may correspond to a distributed computing environment, such as a cluster of servers executing containerized workloads (e.g., Docker, Kubernetes), or an edge device integrated into Internet of Things (IoT) environments. In other embodiments, the computing system 100 may be embedded in another device, such as a vehicle infotainment unit, a medical diagnostic machine, an industrial robot controller, or a wearable computing device.

The computing system 100 includes one or more processors 110 operably coupled to a memory 120 via a system bus 180. The processor 110 may be implemented as a general-purpose central processing unit (CPU), a graphics processing unit (GPU), a tensor processing unit (TPU), a digital signal processor (DSP), or any combination thereof. In some embodiments, the processor 110 may be an application-specific integrated circuit (ASIC) optimized for a particular workload, a field-programmable gate array (FPGA), or a quantum or neuromorphic processor in advanced implementations. The processor 110 may include single-core, multi-core, or many-core configurations and may support hardware virtualization, multithreading, or parallel execution environments to optimize system performance.

The memory 120 may include volatile memory, nonvolatile memory, or a combination thereof. Volatile memory may include system RAM, cache memory, or high-bandwidth memory (HBM). Nonvolatile memory may include flash storage, solid-state drives (SSD), magnetic hard disk drives (HDD), optical storage devices, or persistent memory technologies such as Intel Optane. The memory 120 stores application instructions 140 for carrying out the functionalities described herein and data storage 150 for maintaining information related to system operations. The application instructions 140 may include code written in languages such as C, C++, Java, Python, Go, Rust, or JavaScript, as well as machine learning models trained using frameworks such as TensorFlow or PyTorch. The data storage 150 may contain structured information such as relational database records, unstructured data such as text or images, or real-time telemetry streams. In cloud-based embodiments, the memory 120 may represent scalable storage resources provisioned on-demand through Infrastructure-as-a-Service (IaaS) providers.

The computing system 100 may also include one or more input/output (I/O) devices 130. These devices may encompass visual output devices such as monitors, head-mounted displays, augmented reality (AR) glasses, or projectors; input devices such as keyboards, mice, touchscreens, styluses, or game controllers; and sensor devices such as microphones, cameras, depth sensors, biometric scanners, or environmental sensors. In industrial or medical environments, the I/O devices 130 may include robotic actuators, infusion pumps, or diagnostic imaging scanners. In vehicular environments, the I/O devices 130 may include in-cabin displays, steering sensors, and connected infotainment systems.

The computing system 100 further comprises one or more interfaces 160 that enable communication with other systems, users, or peripheral components. The network interface 165 allows the computing system 100 to exchange data with external systems across a network 190 using wired or wireless protocols. Example communication standards include Ethernet, Wi-Fi, Bluetooth, 5G, Long-Term Evolution (LTE), satellite communication, or emerging protocols such as Wi-Fi 7 or ultra-wideband (UWB). In some embodiments, the network interface 165 supports secure protocols such as HTTPS, TLS, or VPN tunneling to ensure authenticated and encrypted data transfer. The user interface 170 may include APIs, graphical user interfaces (GUIs), command-line interfaces (CLIs), or natural language interfaces enabled through speech recognition or chatbot systems. The peripheral device interface 175 enables connectivity with external hardware such as printers, external storage arrays, or specialized scientific equipment.

The network 190 represents any communication infrastructure capable of facilitating data exchange between computing entities. In some embodiments, the network 190 corresponds to a local area network (LAN) within a home or enterprise environment. In other embodiments, the network 190 may be a wide area network (WAN), a metropolitan area network (MAN), a peer-to-peer (P2P) communication mesh, or the global Internet. The network 190 may employ cloud orchestration layers, software-defined networking (SDN), or edge computing gateways. In high-security applications, the network 190 may implement firewalls, intrusion detection systems, or zero-trust architectures to protect transmitted data.

The computing system 100 is illustrated as being in communication with multiple external devices, including a user computing device 145, an administrator computing device 185, and a third-party computing device 195. The user computing device 145 may be a smartphone, tablet, laptop, or smart appliance configured to execute client-side applications or interact with system services. The administrator computing device 185 may be a workstation or remote management console configured to perform oversight functions such as monitoring, auditing, updating, or troubleshooting. The third-party computing device 195 may represent a partner system, vendor service, or external application interface that exchanges data with the computing system 100 via secure APIs. In cloud or SaaS embodiments, these devices may also include external microservices, data warehouses, or federated learning nodes.

In some embodiments, the computing system 100 may be deployed in a client-server model, where the computing system 100 acts as a backend server managing requests from client devices. In other embodiments, the computing system 100 may function within a cloud-native environment, operating as a microservice within a container orchestration platform. In edge deployments, the computing system 100 may be optimized for low-latency local processing, while synchronizing with centralized cloud infrastructure for data persistence and global coordination.

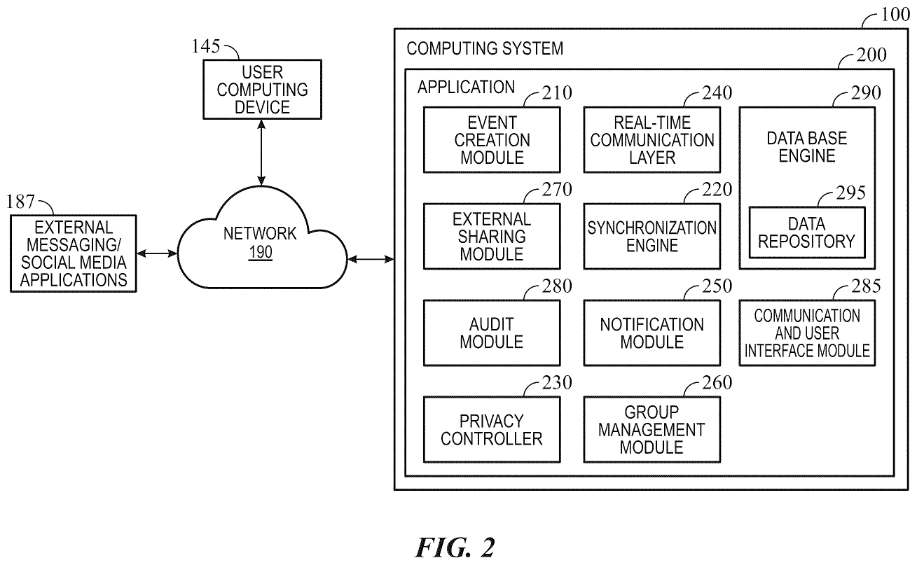

FIG. 2 illustrates an example computer architecture for the application program 200 operated via the computing system 100. The computer system 100 comprises several modules and engines configured to execute the functionalities of the application program 200, and a database engine 290 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of an Event Creation Module 210, a Synchronization Engine 220, a Privacy Controller 230, a Real-Time Communication Layer 240, a Notification Module 250, a Group Management Module 260, an External Sharing Module 270, an Audit Module 280, and a Communication and User Interface Module 285. The application program 200 further interfaces with a Database Engine 290 that manages operations for the Data Repository 295. The computing system 100 communicates via network 190 with external systems including user computing devices 145 and external messaging/social media applications 187.

In some embodiments, the Event Creation Module 210 may be configured to receive event creation input from any authorized member within a defined user group and to generate new event records without restriction to an administrator role. The Event Creation Module 210 may receive event creation input via the Communication and User Interface Module 285 when authorized members submit event details through user interfaces displayed on user computing devices 145. In some embodiments, the Event Creation Module 210 may parse received event creation input to extract event data comprising an event title, a date, a time, a duration, a location, and a visibility setting. The Event Creation Module 210 may validate that the submitting user is an authorized member within the defined user group by querying membership records stored in the Data Repository 295 via the Database Engine 290.

When validation confirms authorized membership, the Event Creation Module 210 may generate a new event record by creating a structured data object containing the parsed event data and associating the event record with the defined user group. The Event Creation Module 210 may transmit the new event record to the Database Engine 290 for storage in the Data Repository 295, where the event record is aggregated with other event records into a unified data repository accessible by a plurality of users via the network 190. The Event Creation Module 210 may transmit the stored event record to the Synchronization Engine 220 for propagation across feed and calendar views, transmit event creation triggers to the Notification Module 250 for push notification generation, and transmit logging requests to the Audit Module 280 for activity documentation. The Event Creation Module 210 enables any authorized member to create events without requiring approval from hosts or administrators, which eliminates coordination bottlenecks that occur when event creation permissions are restricted to specific users.

In some embodiments, the Event Creation Module 210 may be further configured to permit any authorized member of the defined user group to modify an existing event record of the plurality of event records without restriction to a user who originally created the existing event record. The Event Creation Module 210 may receive modification input via the Communication and User Interface Module 285, validate that the modifying user is an authorized member within the defined user group, and update the existing event record with modified event data. The modification may comprise updating at least one of the event title, the date, the time, the duration, the location, or the visibility setting. The Event Creation Module 210 may transmit modified event records to the Database Engine 290 for updated storage in the Data Repository 295 and may trigger synchronization, notification, and audit processes for the modification.

In some embodiments, the Synchronization Engine 220 may be configured to maintain bidirectional data consistency between a feed view and a calendar view. The Synchronization Engine 220 may receive event records or modifications from the Event Creation Module 210 or from the Communication and User Interface Module 285 when users interact with event records through either view. The feed view displays the plurality of event records in a chronological arrangement, presenting events in a scrollable list ordered by date and time. The calendar view displays the plurality of event records organized by date, presenting events within a month-based or week-based grid structure that enables users to visualize event distribution across time periods.

The Synchronization Engine 220 may identify the source view of a modification by analyzing metadata associated with the modification request that indicates whether the user initiated the modification through the feed view or the calendar view. When a modification to an event record of the plurality of event records occurs in one of the feed view or the calendar view, the Synchronization Engine 220 may automatically propagate the modification to the other of the feed view or the calendar view in real-time. The propagation may be accomplished by the Synchronization Engine 220 transmitting update messages to the Communication and User Interface Module 285, which refreshes displayed content on user computing devices 145 without requiring manual page refresh actions by users.

In some embodiments, the Synchronization Engine 220 may verify bidirectional data consistency by comparing event record states across both views after propagation completes and generating consistency verification results. The Synchronization Engine 220 may transmit updated event records to the Database Engine 290 for storage in the Data Repository 295 and may transmit synchronization activity logs to the Audit Module 280 for documentation. The bidirectional synchronization enables users to interact with events through their preferred interface mode while ensuring that all users see consistent, current information regardless of which view they access.

In some embodiments, the Privacy Controller 230 may be configured to assign visibility rules to each event record of the plurality of event records based on the visibility setting. The Privacy Controller 230 may receive event records with associated visibility settings from the Database Engine 290 when users request access to event information. The visibility setting may comprise a friend mode that restricts visibility of the event record to a list of approved contacts associated with a creating user and a community mode that enables visibility of the event record to members who access the defined user group via a shareable link.

The Privacy Controller 230 may determine which visibility mode applies by parsing the visibility setting field within the event record and executing conditional logic that branches based on the parsed value. When the Privacy Controller 230 determines that friend mode applies, the Privacy Controller 230 may retrieve the approved contacts list associated with the creating user from the Data Repository 295 via the Database Engine 290 and may generate an authorized viewer list containing only users present in the approved contacts list. When the Privacy Controller 230 determines that community mode applies, the Privacy Controller 230 may retrieve the member list for the defined user group from the Data Repository 295 via the Database Engine 290, wherein the member list comprises users who have accessed the defined user group via the shareable link.

The Privacy Controller 230 may apply visibility rules by comparing requesting user identifiers against the generated authorized viewer list and returning access authorization results to the Communication and User Interface Module 285. When the requesting user is present in the authorized viewer list, the Privacy Controller 230 may authorize display of the event record. When the requesting user is not present in the authorized viewer list, the Privacy Controller 230 may deny access and prevent display of the event record. The Privacy Controller 230 may transmit visibility assignment logs to the Audit Module 280 for documentation.

In some embodiments, the Privacy Controller 230 may be configured to apply multiple visibility scopes simultaneously to a single event record of the plurality of event records, wherein the multiple visibility scopes comprise at least two of: the friend mode, the community mode, or a link-based mode enabling visibility to users accessing the shareable link generated by the External Sharing Module 270. When a creating user selects multiple visibility scopes during event creation via the Communication and User Interface Module 285, the Privacy Controller 230 may calculate the union of authorized viewers across all selected scopes without merging the underlying social graphs. The Privacy Controller 230 may retrieve the approved contacts list for friend mode visibility, retrieve the group membership list for community mode visibility, and retrieve users who have accessed the shareable link for link-based visibility, combining these lists into a composite authorized viewer list while maintaining the separate data structures for each visibility scope in the Data Repository 295.

In some embodiments, the Privacy Controller 230 may be further configured to apply granular visibility controls to each event record of the plurality of event records. The granular visibility controls may comprise at least one of a hide-from setting that excludes specific contacts from viewing the event record, a guest list visibility setting that controls whether participants can view other participants, or a guest permission setting that controls whether participants can invite additional users to the event record.

In some embodiments, the Real-Time Communication Layer 240 may be configured to transmit collaborative interactions to participants associated with an event record of the plurality of event records. The Real-Time Communication Layer 240 may receive collaborative interactions from participants via the Communication and User Interface Module 285 when participants submit input through event-associated interfaces displayed on user computing devices 145. The collaborative interactions may comprise at least one of status updates indicating a change to the event record, polling enabling participants to vote on event options, attendance response tracking indicating attendance status of participants, or comments posted by participants.

The Real-Time Communication Layer 240 may determine the interaction type by parsing received input to identify whether the submission constitutes a status update, poll response, attendance response, or comment. The Real-Time Communication Layer 240 may transmit the collaborative interaction to the Database Engine 290 for association with the event record in the Data Repository 295, creating a persistent record of the interaction linked to the specific event. The Real-Time Communication Layer 240 may retrieve the participant list associated with the event record from the Data Repository 295 via the Database Engine 290, wherein the participant list comprises user identifiers for all users associated with the event.

In some embodiments, the Real-Time Communication Layer 240 may transmit the collaborative interaction to each participant of the plurality of participants in real-time using persistent connection technologies. The Real-Time Communication Layer 240 may establish WebSocket connections or server-sent event streams with user computing devices 145 via the network 190, enabling immediate delivery of collaborative interactions without requiring participants to refresh their interfaces. The Real-Time Communication Layer 240 may transmit interaction triggers to the Notification Module 250 for push notification generation and may transmit interaction logs to the Audit Module 280 for documentation. The real-time transmission enables participants to engage in collaborative planning discussions within event contexts without switching between separate messaging applications.

In some embodiments, the Real-Time Communication Layer 240 may be configured to store the collaborative interactions in association with the event record in the Data Repository 295 via the Database Engine 290, wherein participants access event-related communication within a single event context without requiring retrieval from external messaging threads. This event-contained communication architecture enables participants to view complete coordination history including status updates, polling responses, attendance responses, and comments within a unified interface associated with the specific event record. By maintaining collaborative interactions within the event record itself, the Real-Time Communication Layer 240 eliminates fragmentation of event-related communication across separate messaging applications where details may become scattered across conversation histories and difficult to locate.

In some embodiments, the polling may comprise a multiple-choice poll interface configured to receive poll responses from participants associated with an event record of the plurality of event records and to display aggregated poll results in real-time. The Real-Time Communication Layer 240 may aggregate poll responses by counting responses for each poll option and calculating response percentages, transmitting updated aggregation results to participants as new responses are received.

In some embodiments, the attendance response tracking may comprise an attendance status indicator for each participant associated with an event record of the plurality of event records. The attendance status indicator may comprise at least one of attending, not attending, or undecided. The Real-Time Communication Layer 240 may display a count of participants for each attendance status indicator by aggregating attendance responses and transmitting count summaries to the Communication and User Interface Module 285 for display.

In some embodiments, the Notification Module 250 may be configured to generate and transmit push notifications to participants associated with an event record of the plurality of event records. The Notification Module 250 may receive notification triggers from the Event Creation Module 210, the Synchronization Engine 220, and the Real-Time Communication Layer 240 when events occur that warrant participant notification. The notification triggers may indicate a new event record creation, a modification to an existing event record of the plurality of event records, or a new collaborative interaction.

The Notification Module 250 may generate push notifications by creating notification payloads containing event identifiers, notification type indicators, and human-readable message content describing the triggering event. The Notification Module 250 may retrieve participant device registration tokens from the Data Repository 295 via the Database Engine 290, wherein the device registration tokens identify specific user computing devices 145 registered to receive push notifications. The Notification Module 250 may transmit push notifications to user computing devices 145 via the network 190 by interfacing with mobile device notification services such as Apple Push Notification Service (APNS) for iOS devices or Firebase Cloud Messaging (FCM) for Android devices, and with web browser notification Application Programming Interfaces (APIs) for web-based access.

In some embodiments, the Notification Module 250 may be configured to generate and transmit push notifications to participants in response to at least one of a new event record creation by the Event Creation Module 210, a modification to an existing event record of the plurality of event records detected by the Synchronization Engine 220, or a new collaborative interaction transmitted by the Real-Time Communication Layer 240. The Notification Module 250 may differentiate notification content based on the trigger type, generating creation notifications containing the event title and scheduled date, modification notifications identifying which event fields were changed, or interaction notifications summarizing the collaborative interaction content such as a new comment or updated attendance response.

In some embodiments, the Group Management Module 260 may be configured to create defined user groups and to generate shareable links for group access. The Group Management Module 260 may receive group creation requests from users via the Communication and User Interface Module 285 when users initiate group creation through interfaces displayed on user computing devices 145. The Group Management Module 260 may create the defined user group by generating a group record containing a unique group identifier, group name, creating user identifier, and creation timestamp, and transmitting the group record to the Database Engine 290 for storage in the Data Repository 295.

The Group Management Module 260 may generate a shareable link for the defined user group by creating a unique Uniform Resource Locator (URL) that encodes the group identifier and authentication parameters. The shareable link may be distributed by users through external messaging or social media applications 187 or through other communication channels. When new users access the shareable link, the Group Management Module 260 may receive access requests via the network 190 and may add new users to the defined user group without requiring administrator approval. The Group Management Module 260 may add new users by creating membership records associating the new user identifiers with the group identifier and storing the membership records in the Data Repository 295 via the Database Engine 290.

In some embodiments, the Group Management Module 260 may associate a username-based identity with each new user without requiring phone number exchange. The Group Management Module 260 may enable user connections via the username-based identity system that associates each user of the plurality of users with a unique username, thereby enabling users to connect without requiring exchange of phone numbers. The username-based identity system may be implemented by the Group Management Module 260 maintaining username records in the Data Repository 295 that associate each username with a user account, enabling users to search for and connect with other users by username rather than by phone number or email address. The Group Management Module 260 may transmit group membership activity logs to the Audit Module 280 for documentation.

In some embodiments, the defined user group may be configured to maintain group membership independently from the list of approved contacts associated with each user, wherein users participate in a common defined user group without requiring establishment of bilateral friend relationships between the users. The Group Management Module 260 maintains group membership records in the Data Repository 295 that are separate and distinct from the approved contacts lists maintained for friend mode visibility determinations by the Privacy Controller 230. This independent maintenance enables users to coordinate within shared groups for community mode events while preserving separate friend relationships for friend mode events. Users within the same defined user group may view and interact with community mode event records without appearing on each other's approved contacts lists, enabling coordination among acquaintances, colleagues, or community members who have not established bilateral social connections.

In some embodiments, the External Sharing Module 270 may be configured to generate a shareable link for an event record of the plurality of event records. The External Sharing Module 270 may receive sharing requests from users via the Communication and User Interface Module 285 when users initiate event sharing through interfaces displayed on user computing devices 145. The External Sharing Module 270 may generate the shareable link by creating a unique URL that encodes the event record identifier and access parameters. The shareable link may be transmittable to external messaging or social media applications 187, enabling users to distribute event information through channels outside the social coordination platform 200. Users accessing the shareable link may be directed to the event record within the social coordination platform 200, enabling event discovery and participation by users who initially encounter the event through external channels.

In some embodiments, the shareable link generated by the External Sharing Module 270 may be transmittable to external messaging or social media applications 187 including text messaging applications, email clients, Instagram, Snapchat, Facebook, Twitter, WhatsApp, Telegram, or similar third-party communication platforms. The External Sharing Module 270 may generate platform-specific sharing intents compatible with mobile operating system sharing frameworks or universal links that enable transmission through native sharing interfaces on user computing devices 145. The shareable link may include Open Graph metadata or similar preview metadata comprising the event title, date, time, and location that external messaging or social media applications 187 may retrieve and render as rich link previews when the shareable link is posted in conversation threads, social media feeds, or story features.

In some embodiments, the Audit Module 280 may be configured to generate a record documenting activity within the social coordination platform 200. The Audit Module 280 may receive logging requests from the Event Creation Module 210, the Synchronization Engine 220, the Privacy Controller 230, the Real-Time Communication Layer 240, the Notification Module 250, the Group Management Module 260, and the External Sharing Module 270 as these components execute their respective functions. The record may comprise a timestamp for each event record creation, each modification to an event record of the plurality of event records, each attendance response, and each collaborative interaction.

The Audit Module 280 may generate timestamped records by associating each logged action with a precise date and time of occurrence retrieved from the computing system 100 clock. The records may include user identifiers, action types, event record identifiers, group identifiers, interaction content, and system decisions. The Audit Module 280 may store generated records in the Data Repository 295 via the Database Engine 290 in a structured format that enables subsequent retrieval and analysis. The comprehensive documentation provided by the Audit Module 280 enables users to review activity histories and understand how coordination evolved over time.

In some embodiments, the Audit Module 280 may be configured to preserve prior field values for each modification to an event record of the plurality of event records, wherein the prior field values enable reconstruction of historical event states. When the Event Creation Module 210 or Synchronization Engine 220 transmits a modification to an existing event record, the Audit Module 280 may generate a modification record containing the event record identifier, the modifying user identifier, the modification timestamp, the modified field identifiers, the prior field values before modification, and the new field values after modification. The preservation of prior field values enables participants to review the evolution of event plans over time and understand the sequence of changes made by different authorized members throughout the event lifecycle.

In some embodiments, the Communication and User Interface Module 285 may be configured to facilitate interactions between users and the social coordination platform 200. The Communication and User Interface Module 285 may generate user interfaces that are transmitted to user computing devices 145 via the network 190 for display on device screens. The Communication and User Interface Module 285 may provide a mobile user interface comprising a tab-based navigation system providing access to the feed view, the calendar view, the Event Creation Module 210, a group management view, and a user profile view.

In some embodiments, the tab-based navigation system may render navigation tabs as icons or labels positioned along a bottom edge or top edge of the mobile user interface on user computing devices 145. Each navigation tab may correspond to a distinct functional area of the social coordination platform 200, wherein selecting the feed view tab displays the plurality of event records in chronological arrangement, selecting the calendar view tab displays the plurality of event records organized by date, selecting the event creation tab initiates the event creation workflow via the Event Creation Module 210, selecting the group management tab displays defined user groups and membership controls via the Group Management Module 260, and selecting the user profile tab displays user account settings, notification preferences, and approved contacts management. The Communication and User Interface Module 285 may highlight the currently selected tab using visual indicators such as color changes or underlines to provide navigation context to users.

The Communication and User Interface Module 285 may display event records retrieved from the Data Repository 295 via the Database Engine 290, presenting event titles, dates, times, durations, locations, and visibility settings in formatted layouts optimized for mobile device screens. Users may interact with displayed interfaces to create event records, modify existing event records, submit collaborative interactions, respond to polls, indicate attendance status, post comments, create groups, join groups via shareable links, and connect with other users via usernames. The Communication and User Interface Module 285 may implement authentication mechanisms to verify user identity before granting access to the social coordination platform 200 and may enforce access controls based on visibility rules determined by the Privacy Controller 230.

In some embodiments, the Database Engine 290 may be configured to manage data storage and retrieval operations for the Data Repository 295. The Database Engine 290 may execute database queries submitted by other components of the application program 200, maintain indexes that enable efficient data retrieval, and ensure data integrity by enforcing constraints on stored data. The Database Engine 290 may manage storage of event records, user records, group membership records, collaborative interaction records, notification records, and audit logs in the Data Repository 295. The Database Engine 290 may support concurrent access by multiple components, enabling the Event Creation Module 210, Synchronization Engine 220, Privacy Controller 230, Real-Time Communication Layer 240, Notification Module 250, Group Management Module 260, External Sharing Module 270, Audit Module 280, and Communication and User Interface Module 285 to read and write data simultaneously without conflicts.

In some embodiments, the computing system 100 may be implemented as a cloud-based server configured to synchronize the Data Repository 295 across a plurality of user computing devices 145 in real-time. This cloud-based architecture may enable real-time visibility into event records, group membership, and collaborative interactions across all user devices accessing the social coordination platform 200.

The cloud-based server implementation may utilize distributed database architectures that replicate event records, user records, group membership records, and collaborative interaction records across multiple geographic regions to reduce access latency for geographically distributed users. The Database Engine 290 may implement eventual consistency or strong consistency protocols to ensure that modifications to event records propagate to all database replicas within acceptable latency thresholds. The Synchronization Engine 220 may coordinate with the cloud-based Database Engine 290 to push data updates to connected user computing devices 145 in real-time, ensuring that users accessing the social coordination platform 200 from different devices or locations view consistent, current event information without synchronization delays.

In some embodiments, the Data Repository 295 may store structured event data used by the application program 200. The Data Repository 295 may contain event records comprising event titles, dates, times, durations, locations, and visibility settings aggregated into a unified data repository. The Data Repository 295 may contain user records including user identifiers, usernames, and approved contacts lists. The Data Repository 295 may contain group membership records associating users with defined user groups. The Data Repository 295 may contain collaborative interaction records including status updates, poll responses, attendance responses, and comments associated with event records. The Data Repository 295 may contain audit logs comprising timestamped records of user actions and system activities. In some embodiments, the Data Repository 295 may be implemented as a relational database, a NoSQL database, or a distributed storage system depending on system requirements and data volumes.

In some embodiments, the network 190 may be a public or private data network, such as the Internet or a corporate intranet, enabling communication between the computing system 100, user computing devices 145, and external messaging/social media applications 187. The network 190 may utilize standard communication protocols such as Transmission Control Protocol/Internet Protocol (TCP/IP), Hypertext Transfer Protocol Secure (HTTPS), WebSocket, or other network protocols to facilitate data transmission between connected systems. In some embodiments, the network 190 may support both wired and wireless connections, enabling user computing devices 145 to access the social coordination platform 200 from various locations and enabling real-time synchronization of event data across geographically distributed users.

User computing devices 145 may be mobile devices such as smartphones or tablets, portable computing devices such as laptops, or fixed workstations such as desktop computers. In some embodiments, user computing devices 145 may execute web browsers or dedicated mobile applications that interface with the Communication and User Interface Module 285 to display event records, group information, and collaborative interactions. Users may interact with user computing devices 145 to create events, modify events, submit attendance responses, participate in polls, post comments, create groups, join groups via shareable links, and connect with other users via usernames. The user computing devices 145 may communicate with the computing system 100 via the network 190 using encrypted connections to maintain data security during transmission of event and user information.

External messaging/social media applications 187 may be third-party communication platforms such as text messaging applications, email clients, or social media applications including Instagram, Snapchat, or similar services. In some embodiments, the External Sharing Module 270 may generate shareable links that can be transmitted through external messaging/social media applications 187, enabling event distribution through channels outside the social coordination platform 200. Users receiving shareable links through external messaging/social media applications 187 may access the links to view event records or join defined user groups within the social coordination platform 200. The integration with external messaging/social media applications 187 enables the social coordination platform 200 to leverage existing communication channels for event and group discovery without requiring all users to actively monitor the platform interface.

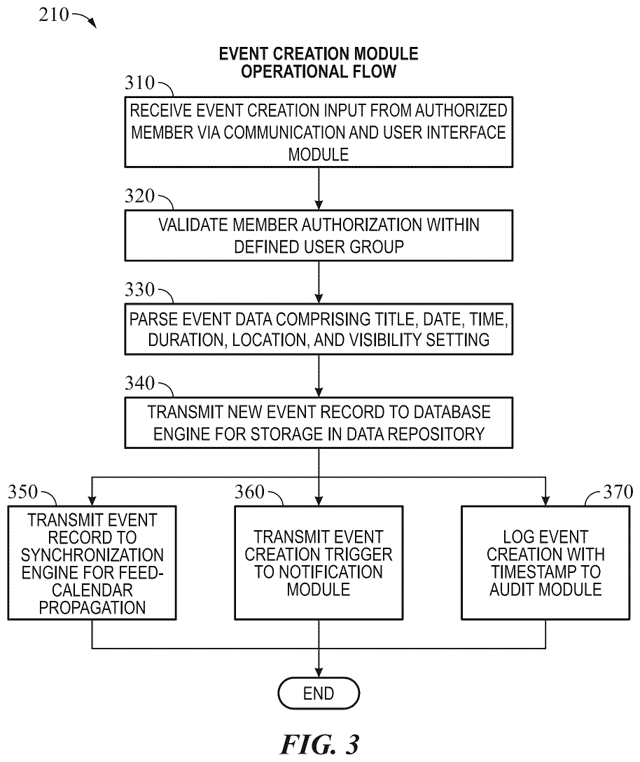

FIG. 3 is a flow diagram illustrating an exemplary operational sequence of the Event Creation Module 210 in accordance with certain embodiments. The sequence shown may be implemented as computer-executable instructions within the application program 200 operating on computing system 100 of FIG. 2, with specific operations performed by the modules depicted therein.

At step 310, event creation input is received from an authorized member via the Communication and User Interface Module 285. This operation may be performed by the Event Creation Module 210 in coordination with the Communication and User Interface Module 285 of FIG. 2. In some embodiments, authorized members may submit event creation input through user interfaces displayed on user computing devices 145 by navigating to an event creation screen, completing form fields for event parameters, and submitting the entered information for processing. The Communication and User Interface Module 285 may receive the submitted input via the network 190 and package the input into a structured request object containing the submitting user identifier, the target group identifier for the defined user group, and the entered event details. The Communication and User Interface Module 285 may forward the structured request object to the Event Creation Module 210 for processing.

At step 320, member authorization is validated within the defined user group. This operation is performed by the Event Creation Module 210, which verifies that the submitting user possesses authorization to create events within the specified group. In some embodiments, the Event Creation Module 210 may extract the submitting user identifier and target group identifier from the structured request object and generate a membership query for transmission to the Database Engine 290. The Database Engine 290 may execute the membership query by searching group membership records in the Data Repository 295 to determine whether an association exists between the submitting user and the target group.

When the membership query returns a valid active membership record, the Event Creation Module 210 may confirm authorization and proceed to subsequent steps. When the query returns no matching record, the Event Creation Module 210 may reject the request and transmit an authorization failure response to the Communication and User Interface Module 285 for display on the user computing device 145. The authorization validation confirms that event creation permissions are granted to each authorized member of the defined user group without restriction to an administrator role, enabling any group member to create events without requiring host approval.

At step 330, event data is parsed comprising title, date, time, duration, location, and visibility setting. This operation is performed by the Event Creation Module 210, which extracts and validates individual data fields from the event creation input. In some embodiments, the Event Creation Module 210 may parse the structured request object by identifying field keys and extracting corresponding values for each event parameter. The Event Creation Module 210 may validate that the event title contains valid characters, that the date conforms to a standardized format such as YYYY-MM-DD, that the time conforms to a format such as HH:MM, and that the duration represents a positive time interval specified in minutes or hours.

The Event Creation Module 210 may extract the location as a text string, street address, or geographic coordinates comprising latitude and longitude values. The Event Creation Module 210 may extract the visibility setting, wherein the visibility setting comprises a friend mode that restricts visibility to approved contacts associated with the creating user and a community mode that enables visibility to members who access the defined user group via a shareable link. Upon successful validation, the Event Creation Module 210 may generate an event data object containing the parsed values.

In some embodiments, the visibility setting may further comprise a public mode that enables visibility of the event record to users within a geographic proximity to the location based on real-time location data. The Privacy Controller 230 may receive real-time location data from user computing devices 145 via the network 190, wherein the real-time location data comprises geographic coordinates obtained from Global Positioning System (GPS) receivers, network-based location services, or Wi-Fi positioning systems integrated within the user computing devices 145. The Privacy Controller 230 may calculate the distance between each requesting user's current geographic coordinates and the event location coordinates stored in the event record using geodesic distance formulas such as the Haversine formula. The Privacy Controller 230 may authorize visibility of the event record when the calculated distance falls within a predetermined proximity threshold such as one mile, five miles, or a custom distance specified by the creating user during event creation.

At step 340, the new event record is transmitted to the Database Engine 290 for storage in the Data Repository 295. This operation is performed by the Event Creation Module 210, which generates a complete event record and persists the record for subsequent access. In some embodiments, the Event Creation Module 210 may generate the new event record by combining the parsed event data with system-generated values including a unique event record identifier generated using a Universally Unique Identifier (UUID) algorithm, the creating user identifier, a creation timestamp, and the group identifier. The Event Creation Module 210 may transmit the event record to the Database Engine 290 using database insertion commands.

The Database Engine 290 may store the new event record in the Data Repository 295, where the event record is aggregated with other event records created by each user of the plurality of users into a unified data repository. In some embodiments, the Data Repository 295 may index event records by event record identifier, group identifier, and date fields to enable efficient retrieval operations.

At step 350, the event record is transmitted to the Synchronization Engine 220 for feed-calendar propagation. This operation is performed by the Event Creation Module 210, which initiates synchronization to make the new event visible across interface views. In some embodiments, the Event Creation Module 210 may generate a synchronization request containing the event record identifier and transmit the request to the Synchronization Engine 220. The Synchronization Engine 220 may propagate the new event record to the feed view, which displays the plurality of event records in a chronological arrangement, and to the calendar view, which displays the plurality of event records organized by date within a month-based or week-based grid structure.

At step 360, an event creation trigger is transmitted to the Notification Module 250. This operation is performed by the Event Creation Module 210, which initiates notification delivery to alert group members. In some embodiments, the Event Creation Module 210 may generate a notification request containing the event record identifier, the defined user group identifier, and a trigger type indicator specifying a new event record creation. The Notification Module 250 may generate push notifications containing the event title and date for transmission to participants associated with the defined user group via the network 190, enabling group members to receive awareness of new events without actively monitoring the social coordination platform 200.

At step 370, the event creation is logged with a timestamp to the Audit Module 280. This operation is performed by the Event Creation Module 210, which documents the creation activity. In some embodiments, the Event Creation Module 210 may transmit a logging request to the Audit Module 280 containing the event record identifier, creating user identifier, action type, and timestamp. The Audit Module 280 may generate an audit record and store the record in the Data Repository 295 via the Database Engine 290, enabling review of event creation history.

In some embodiments, the operations of steps 310 through 370 occur automatically upon receipt of event creation input. The automated execution enables event creation without manual approval workflows, reducing coordination latency. In some embodiments, steps 350, 360, and 370 may execute concurrently to minimize processing time between event creation and visibility to other users.

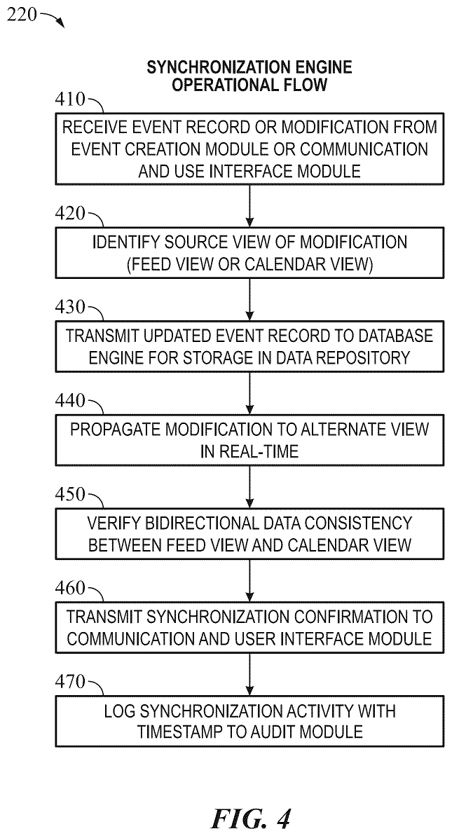

FIG. 4 is a flow diagram illustrating an exemplary operational sequence of the Synchronization Engine 220 in accordance with certain embodiments. The sequence shown may be implemented as computer-executable instructions within the application program 200 operating on computing system 100 of FIG. 2, with specific operations performed by the modules depicted therein.

At step 410, an event record or modification is received from the Event Creation Module 210 or the Communication and User Interface Module 285. This operation may be performed by the Synchronization Engine 220, which receives data requiring propagation across interface views. In some embodiments, the Synchronization Engine 220 may receive new event records from the Event Creation Module 210 when authorized members create events as described in FIG. 3. The Synchronization Engine 220 may also receive modifications to existing event records from the Communication and User Interface Module 285 when users edit event details through interfaces on user computing devices 145. The received data may include the event record identifier, modified field values, and metadata indicating the modification source.

In some embodiments, the Event Creation Module 210 may permit any authorized member of the defined user group to modify an existing event record of the plurality of event records without restriction to a user who originally created the existing event record. Modifications may include changes to the event title, date, time, duration, location, or visibility setting.

At step 420, the source view of modification is identified as either the feed view or the calendar view. This operation is performed by the Synchronization Engine 220, which determines where the modification originated. In some embodiments, the Synchronization Engine 220 may parse metadata associated with the modification request to extract a view identifier. The feed view displays the plurality of event records in a chronological arrangement, presenting events in a scrollable list ordered by date and time. The calendar view displays the plurality of event records organized by date, presenting events within a month-based grid showing days of the month or a week-based grid showing days of the week. In some embodiments, the calendar view may categorize event records into a created category, an attending category, or a past category based on the viewing user's relationship to each event.

In some embodiments, the calendar view may be configured to categorize the plurality of event records into at least one of a created category displaying event records created by a viewing user, an attending category displaying event records for which the viewing user has indicated an attending attendance status via the Real-Time Communication Layer 240, or a past category displaying event records with a date prior to a current date. The Synchronization Engine 220 may determine category assignments for each event record by querying the Data Repository 295 via the Database Engine 290 to retrieve the creating user identifier and any attendance response submitted by the viewing user, and by comparing the event date field against the current system date obtained from the computing system 100. The Communication and User Interface Module 285 may render category assignments as color-coded visual indicators, separate calendar layers that can be toggled on or off, or filterable views enabling users to selectively display or hide event records by category within the calendar view.

At step 430, the updated event record is transmitted to the Database Engine 290 for storage in the Data Repository 295. This operation is performed by the Synchronization Engine 220, which persists the modification before propagating to interface views. In some embodiments, the Synchronization Engine 220 may generate a database update command containing the event record identifier and modified field values. The Database Engine 290 may execute the update command to modify the stored event record, ensuring that the unified data repository reflects the current state. In some embodiments, the Database Engine 290 may implement version tracking to detect concurrent modification conflicts.

At step 440, the modification is propagated to the alternate view in real-time. This operation is performed by the Synchronization Engine 220, which transmits updates to ensure both views reflect consistent information. In some embodiments, when a modification to an event record of the plurality of event records occurs in one of the feed view or the calendar view, the Synchronization Engine 220 may automatically propagate the modification to the other of the feed view or the calendar view in real-time.

The Synchronization Engine 220 may accomplish real-time propagation by transmitting update messages to the Communication and User Interface Module 285 through WebSocket connections established with user computing devices 145 via the network 190. The WebSocket protocol enables full-duplex communication channels over a single Transmission Control Protocol (TCP) connection, enabling the server to push updates to connected clients without requiring client polling. The Communication and User Interface Module 285 may receive update messages and refresh displayed content without requiring manual page refresh actions by users.

At step 450, bidirectional data consistency is verified between the feed view and the calendar view. This operation is performed by the Synchronization Engine 220, which confirms successful propagation. In some embodiments, the Synchronization Engine 220 may query the Data Repository 295 via the Database Engine 290 to retrieve the current event record state and compare against expected values. When verification detects inconsistency, the Synchronization Engine 220 may initiate corrective operations by re-transmitting update messages to affected user computing devices 145.

At step 460, a synchronization confirmation is transmitted to the Communication and User Interface Module 285. This operation is performed by the Synchronization Engine 220, which notifies the interface layer of completion. In some embodiments, the Synchronization Engine 220 may generate a confirmation message containing the event record identifier and synchronization status. The Communication and User Interface Module 285 may update interfaces on user computing devices 145 to indicate that modifications have been saved and synchronized.

At step 470, synchronization activity is logged with a timestamp to the Audit Module 280. This operation is performed by the Synchronization Engine 220, which documents synchronization operations. In some embodiments, the Synchronization Engine 220 may transmit a logging request containing the event record identifier, source view, target view, and timestamp. The Audit Module 280 may store the record in the Data Repository 295 via the Database Engine 290.

In some embodiments, the operations of steps 410 through 470 occur automatically each time event records are created or modified, ensuring the feed view and calendar view maintain consistent information without manual synchronization by users.

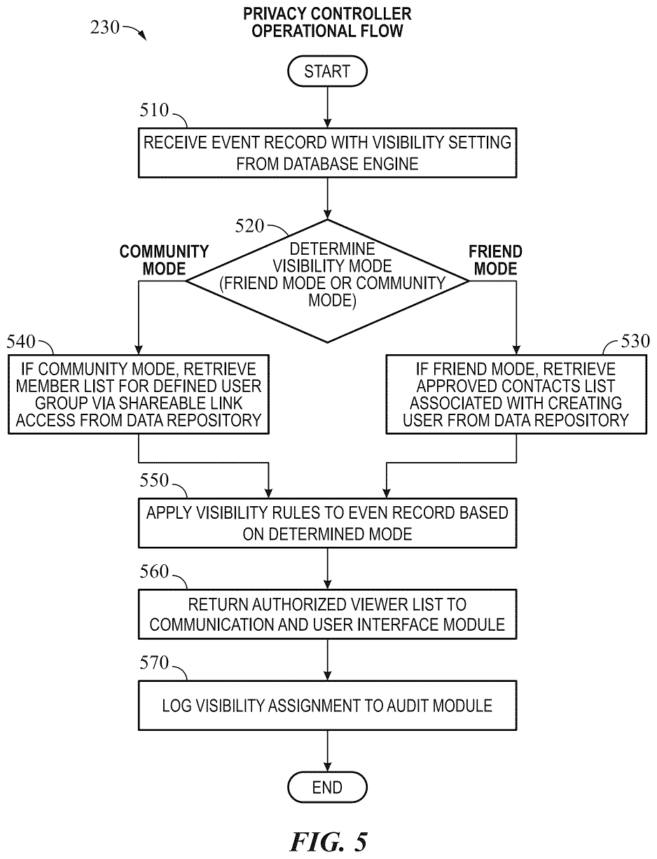

FIG. 5 is a flow diagram illustrating an exemplary operational sequence of the Privacy Controller 230 in accordance with certain embodiments. The sequence shown may be implemented as computer-executable instructions within the application program 200 operating on computing system 100 of FIG. 2, with specific operations performed by the modules depicted therein.

At step 510, an event record with visibility setting is received from the Database Engine 290. This operation may be performed by the Privacy Controller 230, which receives event data requiring visibility determination. In some embodiments, the Privacy Controller 230 may receive event records when users request access to event information through the Communication and User Interface Module 285. The Database Engine 290 may retrieve the requested event record from the Data Repository 295 and transmit the record to the Privacy Controller 230, wherein the record includes the visibility setting that indicates which privacy mode applies.

At step 520, the visibility mode is determined as either friend mode or community mode. This operation is performed by the Privacy Controller 230, which evaluates the visibility setting to identify the applicable privacy configuration. In some embodiments, the Privacy Controller 230 may parse the visibility setting field within the event record and execute conditional branching logic based on the parsed value. The visibility setting may comprise a friend mode that restricts visibility of the event record to a list of approved contacts associated with a creating user and a community mode that enables visibility of the event record to members who access the defined user group via a shareable link. The determination directs processing to step 530 for friend mode or step 540 for community mode.

At step 530, when friend mode is determined, the approved contacts list associated with the creating user is retrieved from the Data Repository 295. This operation is performed by the Privacy Controller 230 when step 520 indicates friend mode. In some embodiments, the Privacy Controller 230 may extract the creating user identifier from the event record and generate a query requesting the approved contacts list for that user. The Database Engine 290 may execute the query and return the approved contacts list containing user identifiers for contacts the creating user has approved. The approved contacts list may be maintained by users through contact management interfaces where users can add, remove, or organize contacts into groups.

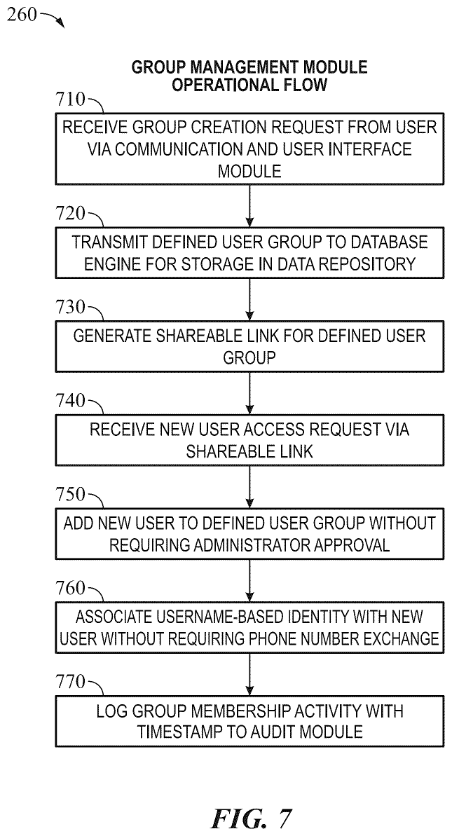

At step 540, when community mode is determined, the member list for the defined user group is retrieved from the Data Repository 295. This operation is performed by the Privacy Controller 230 when step 520 indicates community mode. In some embodiments, the Privacy Controller 230 may extract the group identifier from the event record and generate a query requesting membership records for the defined user group. The Database Engine 290 may return the member list comprising user identifiers for users who have accessed the defined user group via the shareable link. The member list reflects users added through the link-based joining mechanism described in FIG. 7.

At step 550, visibility rules are applied to the event record based on the determined mode. This operation is performed by the Privacy Controller 230, which generates authorization determinations. In some embodiments, the Privacy Controller 230 may receive a requesting user identifier from the Communication and User Interface Module 285 and compare it against the authorized viewer list retrieved at step 530 or step 540 by executing a set membership check. When the requesting user identifier is present in the list, the Privacy Controller 230 generates a positive authorization permitting display. When the identifier is absent, the Privacy Controller 230 generates a negative authorization denying display.

In some embodiments, the Privacy Controller 230 may apply granular visibility controls comprising a hide-from setting that excludes specific contacts, a guest list visibility setting controlling whether participants can view other participants, or a guest permission setting controlling whether participants can invite additional users.

In some embodiments, the hide-from setting may enable the creating user to specify individual contacts from the approved contacts list who should be excluded from viewing the event record despite otherwise satisfying friend mode visibility rules. The Privacy Controller 230 may implement the hide-from setting by maintaining an exclusion list associated with the event record in the Data Repository 295 and filtering the authorized viewer list generated at step 530 to remove user identifiers present in the exclusion list before returning results to the Communication and User Interface Module 285. The guest list visibility setting may control whether participants associated with an event record can view the identities and usernames of other participants, enabling the creating user to configure events where attendance information remains private among participants. The guest permission setting may control whether participants can generate additional shareable links for the event record via the External Sharing Module 270 to invite additional users, enabling the creating user to restrict event distribution to direct invitations only or to enable viral sharing through participant networks.

At step 560, the authorized viewer list is returned to the Communication and User Interface Module 285. This operation is performed by the Privacy Controller 230, which transmits visibility results for interface enforcement. In some embodiments, the Privacy Controller 230 may transmit the authorization result and authorized viewer list to the Communication and User Interface Module 285. The Communication and User Interface Module 285 may display the event record on user computing devices 145 when authorization is positive or withhold the record when authorization is negative.

At step 570, visibility assignment is logged to the Audit Module 280. This operation is performed by the Privacy Controller 230, which documents visibility determinations. In some embodiments, the Privacy Controller 230 may transmit a logging request containing the event record identifier, determined visibility mode, requesting user identifier, authorization result, and timestamp. The Audit Module 280 may store the record in the Data Repository 295 via the Database Engine 290.

In some embodiments, the operations of steps 510 through 570 occur automatically each time users request access to event records, ensuring consistent privacy enforcement without manual access control management.

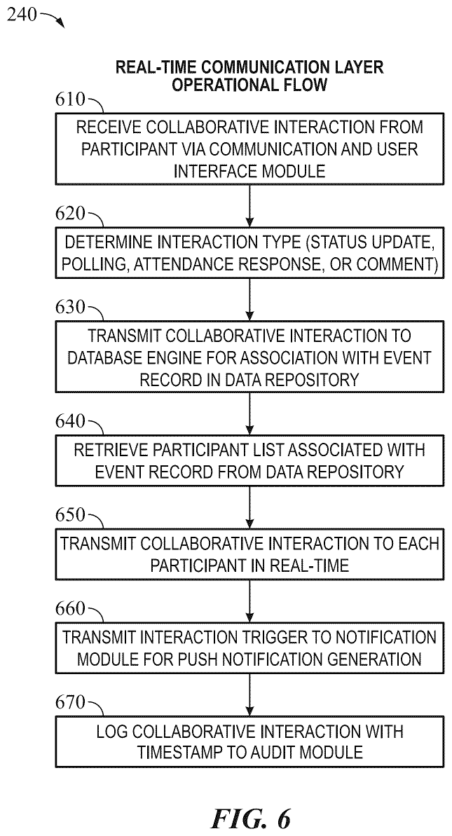

FIG. 6 is a flow diagram illustrating an exemplary operational sequence of the Real-Time Communication Layer 240 in accordance with certain embodiments. The sequence shown may be implemented as computer-executable instructions within the application program 200 operating on computing system 100 of FIG. 2, with specific operations performed by the modules depicted therein.

At step 610, a collaborative interaction is received from a participant via the Communication and User Interface Module 285. This operation may be performed by the Real-Time Communication Layer 240, which receives input requiring distribution to event participants. In some embodiments, participants may submit collaborative interactions through interfaces displayed on user computing devices 145 by entering content and submitting for processing. The Communication and User Interface Module 285 may package the input into an interaction object containing participant identifier, event record identifier, and interaction content, and forward the object to the Real-Time Communication Layer 240 via the network 190.

At step 620, the interaction type is determined as a status update, polling, attendance response, or comment. This operation is performed by the Real-Time Communication Layer 240, which categorizes the received interaction. In some embodiments, the Real-Time Communication Layer 240 may parse the interaction object to extract a type identifier. The collaborative interactions may comprise at least one of status updates indicating a change to the event record, polling enabling participants to vote on event options, attendance response tracking indicating attendance status of participants, or comments posted by participants.

In some embodiments, the status updates may comprise at least one of a weather-related delay indicating that the event start time has been postponed due to weather conditions, an indication that a participant capacity has been reached preventing additional attendance responses, a location change indicating that the event will occur at a different location than originally specified, or a cancellation of an event record indicating that the event will no longer occur. The Real-Time Communication Layer 240 may associate each status update type with a visual indicator such as an icon or color code that the Communication and User Interface Module 285 renders on user computing devices 145 to enable participants to quickly identify the nature of the status change.

In some embodiments, status updates may comprise at least one of a weather-related delay, an indication that a participant capacity has been reached, a location change, or a cancellation of an event record. In some embodiments, the polling may comprise a multiple-choice poll interface configured to receive poll responses and display aggregated results in real-time. In some embodiments, the attendance response tracking may comprise an attendance status indicator for each participant, wherein the indicator comprises at least one of attending, not attending, or undecided.

At step 630, the collaborative interaction is transmitted to the Database Engine 290 for association with the event record in the Data Repository 295. This operation is performed by the Real-Time Communication Layer 240, which persists the interaction. In some embodiments, the Real-Time Communication Layer 240 may generate a database insertion command containing the interaction content, type, participant identifier, event record identifier, and submission timestamp. The Database Engine 290 may store the interaction with an association to the corresponding event record of the plurality of event records, enabling participants to view interaction history.

At step 640, the participant list associated with the event record is retrieved from the Data Repository 295. This operation is performed by the Real-Time Communication Layer 240, which identifies recipients for distribution. In some embodiments, the Real-Time Communication Layer 240 may query the Database Engine 290 with the event record identifier. The Database Engine 290 may return the participant list comprising user identifiers for all users associated with the event record.

At step 650, the collaborative interaction is transmitted to each participant in real-time. This operation is performed by the Real-Time Communication Layer 240, which distributes the interaction to associated participants. In some embodiments, the Real-Time Communication Layer 240 may transmit the collaborative interaction to each participant of the plurality of participants in real-time using WebSocket connections maintained with user computing devices 145 via the network 190. For each participant in the list, the Real-Time Communication Layer 240 may generate an update message containing the interaction content and transmit through the established connection, enabling immediate delivery without requiring interface refresh.

In some embodiments, the polling may comprise a multiple-choice poll interface configured to receive poll responses from participants associated with an event record of the plurality of event records and to display aggregated poll results in real-time. The Real-Time Communication Layer 240 may generate poll interfaces containing a poll question and a plurality of poll options defined by the poll creator. When participants submit poll responses by selecting one or more poll options, the Real-Time Communication Layer 240 may aggregate poll responses by incrementing response counters for each selected option and calculating response percentages. The Real-Time Communication Layer 240 may transmit updated aggregation results to all participants associated with the event record each time a new poll response is received, enabling participants to view current poll standings without manual refresh.

In some embodiments, the attendance response tracking may comprise an attendance status indicator for each participant associated with an event record of the plurality of event records, wherein the attendance status indicator comprises at least one of attending, not attending, or undecided. The Real-Time Communication Layer 240 may be configured to display a count of the plurality of participants for each attendance status indicator by aggregating attendance responses stored in the Data Repository 295 via the Database Engine 290 and transmitting the aggregated counts to the Communication and User Interface Module 285. The Communication and User Interface Module 285 may render the counts on user computing devices 145 as numerical indicators displayed adjacent to each attendance status option, enabling participants to view current attendance totals such as the number of participants who have indicated attending status without manually counting individual responses.

In some embodiments, for polling interactions, the Real-Time Communication Layer 240 may aggregate poll responses by counting responses for each option and transmit updated aggregation results as new responses arrive. For attendance response interactions, the Real-Time Communication Layer 240 may update and transmit participant counts for each attendance status.

At step 660, an interaction trigger is transmitted to the Notification Module 250 for push notification generation. This operation is performed by the Real-Time Communication Layer 240, which initiates notifications for participants without active connections. In some embodiments, the Real-Time Communication Layer 240 may generate a notification trigger containing the event record identifier, interaction type, and participant list. The Notification Module 250 may generate push notifications for participants who lack active WebSocket connections, ensuring all participants receive awareness of new collaborative interactions.

At step 670, the collaborative interaction is logged with a timestamp to the Audit Module 280. This operation is performed by the Real-Time Communication Layer 240, which documents interactions. In some embodiments, the Real-Time Communication Layer 240 may transmit a logging request containing interaction content, type, participant identifier, event record identifier, and timestamp. The Audit Module 280 may store the record in the Data Repository 295 via the Database Engine 290.

In some embodiments, the operations of steps 610 through 670 occur automatically each time participants submit collaborative interactions, enabling real-time communication without manual distribution management.

FIG. 7 is a flow diagram illustrating an exemplary operational sequence of the Group Management Module 260 in accordance with certain embodiments. The sequence shown may be implemented as computer-executable instructions within the application program 200 operating on computing system 100 of FIG. 2, with specific operations performed by the modules depicted therein.

At step 710, a group creation request is received from a user via the Communication and User Interface Module 285. This operation may be performed by the Group Management Module 260, which receives requests to create coordination groups. In some embodiments, users may submit group creation requests through interfaces displayed on user computing devices 145 by entering group details such as group name and description and submitting for processing. The Communication and User Interface Module 285 may package the request into a group creation object containing the creating user identifier and group parameters and forward to the Group Management Module 260 via the network 190.

At step 720, the defined user group is transmitted to the Database Engine 290 for storage in the Data Repository 295. This operation is performed by the Group Management Module 260, which creates and persists the group record. In some embodiments, the Group Management Module 260 may generate a group record containing a unique group identifier generated using a UUID algorithm, the group name, description, creating user identifier, and creation timestamp. The Group Management Module 260 may transmit the group record to the Database Engine 290 using database insertion commands. The Database Engine 290 may store the record, establishing the defined user group as an entity for containing member associations and event records. The Group Management Module 260 may also create an initial membership record associating the creating user with the group.

At step 730, a shareable link is generated for the defined user group. This operation is performed by the Group Management Module 260, which creates a distribution mechanism for group access. In some embodiments, the Group Management Module 260 may generate the shareable link by creating a unique Uniform Resource Locator (URL) that encodes the group identifier and a cryptographic authentication token. The URL may combine a base domain address such as “https://platform.example.com/join/” with the group identifier and token as path or query parameters. The generated shareable link may be stored in the Data Repository 295 in association with the group record.

The Group Management Module 260 may transmit the shareable link to the Communication and User Interface Module 285 for display to the creating user, enabling distribution through external messaging or social media applications. In some embodiments, shareable links may include expiration timestamps or usage limits that the Group Management Module 260 validates when processing access requests.

At step 740, a new user access request is received via the shareable link. This operation is performed by the Group Management Module 260, which receives requests from users attempting to join. In some embodiments, when a new user accesses the shareable link through a browser or application on a user computing device 145, the network 190 may route the request to the computing system 100. The Group Management Module 260 may receive the access request containing the encoded group identifier and authentication token. The Group Management Module 260 may validate the token by comparing against stored values and verifying that the link has not expired or been revoked.

At step 750, the new user is added to the defined user group without requiring administrator approval. This operation is performed by the Group Management Module 260, which enables open group joining. In some embodiments, the Group Management Module 260 may create a membership record associating the new user identifier with the group identifier and transmit the record to the Database Engine 290 for storage in the Data Repository 295. The membership addition occurs without requiring administrator approval, enabling users to join immediately upon accessing valid shareable links. This link-based mechanism eliminates approval workflows that create coordination delays.

At step 760, a username-based identity is associated with the new user without requiring phone number exchange. This operation is performed by the Group Management Module 260, which establishes user identity through usernames. In some embodiments, the Group Management Module 260 may enable user connections via a username-based identity system that associates each user of the plurality of users with a unique username, thereby enabling users to connect without requiring exchange of phone numbers.

The Group Management Module 260 may query the Data Repository 295 via the Database Engine 290 to retrieve or create a username record for the new user. When the new user lacks an existing username, the Group Management Module 260 may prompt username creation through the Communication and User Interface Module 285, validating that the entered username is unique by querying existing username records. The username may be stored in association with the user record and membership record, enabling group members to identify the new user by username rather than phone number or email address.

At step 770, group membership activity is logged with a timestamp to the Audit Module 280. This operation is performed by the Group Management Module 260, which documents membership changes. In some embodiments, the Group Management Module 260 may transmit a logging request containing the group identifier, new user identifier, username, membership action type, and timestamp. The Audit Module 280 may store the record in the Data Repository 295 via the Database Engine 290, enabling review of membership history.

In some embodiments, the operations of steps 710 through 770 enable flexible group creation and membership management without centralized administrator control. The shareable link mechanism enables distribution through existing communication channels while automatic membership addition eliminates approval bottlenecks. The username-based identity preserves privacy by enabling connections without phone number disclosure.

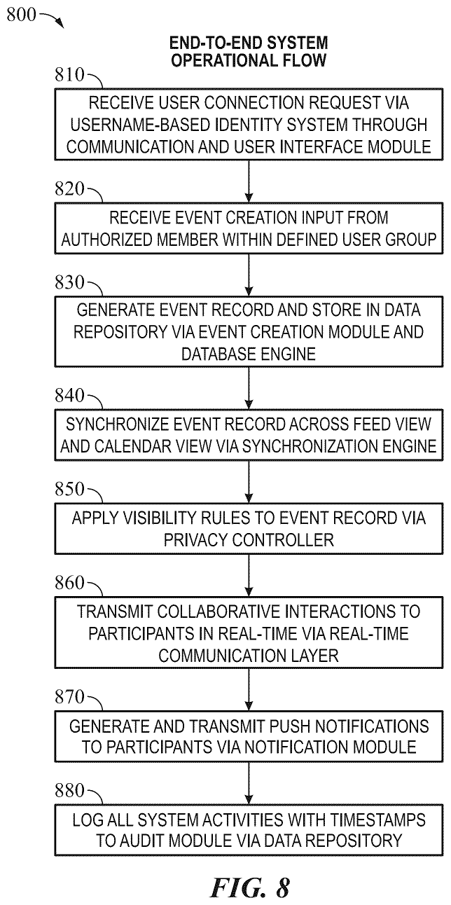

FIG. 8 is a flow diagram illustrating an exemplary end-to-end system operational flow 800 in accordance with certain embodiments. The sequence shown may be implemented as computer-executable instructions within the application program 200 operating on computing system 100 of FIG. 2, demonstrating the integrated operation of multiple modules to process social coordination requests from initial user connection through event creation, synchronization, and collaborative interaction.

At step 810, a user connection request is received via the username-based identity system through the Communication and User Interface Module 285. This operation may be performed by the Group Management Module 260 in coordination with the Communication and User Interface Module 285. In some embodiments, users may submit connection requests by searching for other users by username through interfaces displayed on user computing devices 145 via the network 190. The username-based identity system associates each user of the plurality of users with a unique username, enabling users to connect without requiring exchange of phone numbers.

The Communication and User Interface Module 285 may receive the connection request and forward to the Group Management Module 260, which may query the Data Repository 295 via the Database Engine 290 to locate the target user by username. When found, the Group Management Module 260 may create a connection record or add the requesting user to the target user's approved contacts list, establishing the relationship that enables friend mode visibility for subsequent event creation.

At step 820, event creation input is received from an authorized member within the defined user group. This operation may be performed by the Event Creation Module 210 as described in detail in FIG. 3. In some embodiments, the authorized member may submit event creation input through the Communication and User Interface Module 285 by completing form fields for event parameters including title, date, time, duration, location, and visibility setting. The Event Creation Module 210 may validate that the submitting user holds active membership within the defined user group, confirming that event creation permissions are granted without restriction to an administrator role.

At step 830, an event record is generated and stored in the Data Repository 295 via the Event Creation Module 210 and Database Engine 290. This operation integrates the parsing and storage functions described in FIG. 3. In some embodiments, the Event Creation Module 210 may parse the event creation input to extract event data and generate a new event record combining the parsed data with system-generated values including a unique event record identifier, creating user identifier, and creation timestamp. The Database Engine 290 may store the event record in the Data Repository 295, where the record is aggregated with other event records into a unified data repository accessible by authorized users.

At step 840, the event record is synchronized across the feed view and the calendar view via the Synchronization Engine 220. This operation implements the bidirectional synchronization described in FIG. 4. In some embodiments, the Synchronization Engine 220 may propagate the event record to the feed view, which displays the plurality of event records in a chronological arrangement, and to the calendar view, which displays the plurality of event records organized by date within a month-based or week-based grid. The Synchronization Engine 220 may transmit update messages through WebSocket connections to user computing devices 145, enabling the event to appear across views without manual refresh.

At step 850, visibility rules are applied to the event record via the Privacy Controller 230. This operation implements the privacy enforcement described in FIG. 5. In some embodiments, the Privacy Controller 230 may determine whether friend mode or community mode applies based on the visibility setting and retrieve the corresponding authorized viewer list from the Data Repository 295. The Privacy Controller 230 may apply visibility rules by comparing requesting user identifiers against the authorized viewer list, authorizing display for users present in the list and denying access for users absent from the list.

At step 860, collaborative interactions are transmitted to participants in real-time via the Real-Time Communication Layer 240. This operation implements the interaction distribution described in FIG. 6. In some embodiments, when participants submit collaborative interactions comprising status updates, polling, attendance responses, or comments, the Real-Time Communication Layer 240 may transmit the interactions to each participant of the plurality of participants in real-time through WebSocket connections established with user computing devices 145. The real-time transmission enables collaborative planning discussions within event contexts without requiring participants to refresh interfaces.

At step 870, push notifications are generated and transmitted to participants via the Notification Module 250. This operation integrates notification functionality across event lifecycle activities. In some embodiments, the Notification Module 250 may generate push notifications in response to triggers from the Event Creation Module 210 indicating new event record creation, from the Synchronization Engine 220 indicating modifications to existing event records, or from the Real-Time Communication Layer 240 indicating new collaborative interactions. The Notification Module 250 may transmit push notifications to user computing devices 145 via the network 190 through platform notification services, enabling participants to receive awareness of coordination activities without actively monitoring the social coordination platform 200.

At step 880, all system activities are logged with timestamps to the Audit Module 280 via the Data Repository 295. This operation integrates audit functionality across all modules. In some embodiments, the Audit Module 280 may receive logging requests from the Event Creation Module 210, Synchronization Engine 220, Privacy Controller 230, Real-Time Communication Layer 240, Notification Module 250, and Group Management Module 260 as these components execute operations. The Audit Module 280 may generate timestamped records documenting event record creation, modifications, attendance responses, collaborative interactions, visibility determinations, and group membership changes. The Database Engine 290 may store the audit records in the Data Repository 295, creating comprehensive activity documentation.

In some embodiments, the operations of steps 810 through 880 represent the complete end-to-end workflow for social coordination within the platform 200. The integrated operation of multiple modules enables the system to establish user connections via usernames, create events without administrator approval, synchronize events across feed and calendar views, enforce privacy rules, distribute collaborative interactions in real-time, deliver push notifications, and maintain audit trails. This coordinated workflow automates coordination processes that traditionally required fragmented communication across multiple messaging threads and isolated event pages, eliminating manual synchronization and reducing coordination latency for users.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrases “computing device” or “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A computer-implemented social coordination system for facilitating immediate and scheduled event planning among users, the system comprising:
at least one user device in operable communication with a network;
a server in operable communication with the at least one user device over the network, the server configured to host a social coordination platform comprising:
an event database stored in a memory and accessible by a plurality of users via the network, the event database configured to store a plurality of event records, each event record of the plurality of event records comprising an event title, a date, a time, a duration, a location, and a visibility setting, wherein the event database aggregates event records created by each user of the plurality of users into a unified data repository;
an event creation module configured to receive event creation input from any authorized member within a defined user group and to generate a new event record in the event database based on the event creation input, wherein event creation permissions are granted to each authorized member of the defined user group without restriction to an administrator role;
a synchronization engine configured to maintain bidirectional data consistency between a feed view and a calendar view, wherein the feed view displays the plurality of event records in a chronological arrangement, wherein the calendar view displays the plurality of event records organized by date, and wherein a modification to an event record of the plurality of event records in one of the feed view or the calendar view is automatically propagated to the other of the feed view or the calendar view in real-time;
a privacy controller configured to assign visibility rules to each event record of the plurality of event records based on the visibility setting, wherein the visibility setting comprises a friend mode that restricts visibility of the event record to a list of approved contacts associated with a creating user and a community mode that enables visibility of the event record to members who access the defined user group via a shareable link;
a real-time communication layer configured to transmit collaborative interactions to participants associated with an event record of the plurality of event records, wherein the collaborative interactions comprise at least one of status updates indicating a change to the event record, polling enabling participants to vote on event options, attendance response tracking indicating attendance status of participants, or comments posted by participants; and
wherein the social coordination platform enables user connections via a username-based identity system that associates each user of the plurality of users with a unique username, thereby enabling users to connect without requiring exchange of phone numbers.

2. The system of claim 1, wherein the event creation module is further configured to permit any authorized member of the defined user group to modify an existing event record of the plurality of event records without restriction to a user who originally created the existing event record.

3. The system of claim 1, wherein the social coordination platform further comprises a notification module configured to transmit push notifications to participants associated with an event record of the plurality of event records in response to a new event record creation, a modification to an existing event record of the plurality of event records, or a new collaborative interaction.

4. The system of claim 1, wherein the status updates comprise at least one of a weather-related delay, an indication that a participant capacity has been reached, a location change, or a cancellation of an event record of the plurality of event records.

5. The system of claim 1, wherein the polling comprises a multiple-choice poll interface configured to receive poll responses from participants associated with an event record of the plurality of event records and to display aggregated poll results in real-time.

6. The system of claim 1, wherein the attendance response tracking comprises an attendance status indicator for each participant associated with an event record of the plurality of event records, wherein the attendance status indicator comprises at least one of attending, not attending, or undecided.

7. The system of claim 1, wherein the privacy controller is further configured to apply granular visibility controls to each event record of the plurality of event records, wherein the granular visibility controls comprise at least one of a hide-from setting, a guest list visibility setting, or a guest permission setting.

8. The system of claim 1, wherein the calendar view is configured to categorize the plurality of event records into at least one of a created category, an attending category, or a past category.

9. The system of claim 1, wherein the visibility setting further comprises a public mode enabling visibility of an event record of the plurality of event records to users within a geographic proximity to the location based on real-time location data.

10. The system of claim 1, wherein the social coordination platform provides a mobile user interface comprising a tab-based navigation system providing access to the feed view, the calendar view, the event creation module, a group management view, and a user profile view.

11. The system of claim 1, wherein the social coordination platform further comprises an external sharing module configured to generate a shareable link for an event record of the plurality of event records transmittable to external messaging or social media applications.

12. The system of claim 1, wherein the server is a cloud-based server configured to synchronize the event database across a plurality of user devices in real-time.

13. The system of claim 1, wherein the social coordination platform further comprises a group management module configured to generate the shareable link for the defined user group, wherein a new user is added to the defined user group upon accessing the shareable link without requiring administrator approval.

14. The system of claim 1, wherein the social coordination platform further comprises an audit module configured to generate a record comprising a timestamp for each event record creation, each modification to an event record of the plurality of event records, and each collaborative interaction.

15. The system of claim 1, wherein the real-time communication layer is configured to store the collaborative interactions in association with the event record in the event database, wherein participants access event-related communication within a single event context without requiring retrieval from external messaging threads.

16. The system of claim 14, wherein the audit module is configured to preserve prior field values for each modification to an event record of the plurality of event records, wherein the prior field values enable reconstruction of historical event states.

17. The system of claim 1, wherein the defined user group is configured to maintain group membership independently from the list of approved contacts associated with each user, wherein users participate in a common defined user group without requiring establishment of bilateral friend relationships between the users.

18. The system of claim 1, wherein the privacy controller is configured to apply multiple visibility scopes simultaneously to a single event record of the plurality of event records, wherein the multiple visibility scopes comprise at least two of: the friend mode, the community mode, or a link-based mode enabling visibility to users accessing the shareable link generated by the external sharing module.

19. A computer-implemented method for facilitating immediate and scheduled event planning among users, the method executed by at least one processor of a computing device, the method comprising:
storing, via the computing device, a plurality of event records in an event database accessible by a plurality of users via a network, each event record of the plurality of event records comprising an event title, a date, a time, a duration, a location, and a visibility setting;
receiving, via the computing device, event creation input from any authorized member within a defined user group;
generating, via the computing device, a new event record in the event database based on the event creation input, wherein event creation permissions are granted to each authorized member of the defined user group without restriction to an administrator role;
synchronizing, via the computing device, a feed view and a calendar view to maintain bidirectional data consistency, wherein the feed view displays the plurality of event records in a chronological arrangement, wherein the calendar view displays the plurality of event records organized by date, and wherein a modification to an event record of the plurality of event records in one of the feed view or the calendar view is automatically propagated to the other of the feed view or the calendar view in real-time;
assigning, via the computing device, visibility rules to each event record of the plurality of event records based on the visibility setting, wherein the visibility setting comprises a friend mode that restricts visibility of the event record to a list of approved contacts associated with a creating user and a community mode that enables visibility of the event record to members who access the defined user group via a shareable link;
transmitting, via the computing device, collaborative interactions to participants associated with an event record of the plurality of event records, wherein the collaborative interactions comprise at least one of status updates indicating a change to the event record, polling enabling participants to vote on event options, attendance response tracking indicating attendance status of participants, or comments posted by participants; and
enabling, via the computing device, user connections via a username-based identity system that associates each user of the plurality of users with a unique username without requiring exchange of phone numbers.

20. The method of claim 19, further comprising permitting, via the computing device, any authorized member of the defined user group to modify an existing event record of the plurality of event records without restriction to a user who originally created the existing event record.

21. The method of claim 19, further comprising transmitting, via the computing device, push notifications to participants associated with an event record of the plurality of event records in response to a new event record creation, a modification to an existing event record of the plurality of event records, or a new collaborative interaction.

22. The method of claim 19, further comprising generating, via the computing device, a shareable link for the defined user group, wherein a new user is added to the defined user group upon accessing the shareable link without requiring administrator approval.

23. A software product comprising at least one non-transitory computer-readable storage medium having application instructions stored on the at least one non-transitory computer-readable storage medium, the application instructions executable by at least one processor to:
store a plurality of event records in an event database accessible by a plurality of users via a network, each event record of the plurality of event records comprising an event title, a date, a time, a duration, a location, and a visibility setting, wherein the event database aggregates event records created by each user of the plurality of users into a unified data repository;
receive event creation input from any authorized member within a defined user group and generate a new event record in the event database based on the event creation input, wherein event creation permissions are granted to each authorized member of the defined user group without restriction to an administrator role;
synchronize a feed view and a calendar view to maintain bidirectional data consistency, wherein the feed view displays the plurality of event records in a chronological arrangement, wherein the calendar view displays the plurality of event records organized by date, and wherein a modification to an event record of the plurality of event records in one of the feed view or the calendar view is automatically propagated to the other of the feed view or the calendar view in real-time;
assign visibility rules to each event record of the plurality of event records based on the visibility setting, wherein the visibility setting comprises a friend mode that restricts visibility of the event record to a list of approved contacts associated with a creating user and a community mode that enables visibility of the event record to members who access the defined user group via a shareable link;
transmit collaborative interactions to participants associated with an event record of the plurality of event records, wherein the collaborative interactions comprise at least one of status updates indicating a change to the event record, polling enabling participants to vote on event options, attendance response tracking indicating attendance status of participants, or comments posted by participants; and
enable user connections via a username-based identity system that associates each user of the plurality of users with a unique username without requiring exchange of phone numbers.

24. The software product of claim 23, wherein the application instructions are further executable to permit any authorized member of the defined user group to modify an existing event record of the plurality of event records without restriction to a user who originally created the existing event record, and to transmit push notifications to participants associated with the existing event record in response to the modification.
